(19) United States
(12) Patent Application Publication
(10) Pub. No.: US 2024/0249850 A1
(43) Pub. Date: Jul. 25, 2024

(54) NUCLEAR FUSION REACTOR BLANKET AND NUCLEAR FUSION REACTOR

(71) Applicant: Kyoto Fusioneering Ltd., Chiyoda-ku, Tokyo (JP)

(72) Inventors: Keisuke MUKAI, Tokyo (JP); Satoshi KONISHI, Tokyo (JP); Richard PEARSON, Tokyo (JP)

(21) Appl. No.: 18/443,382

(22) Filed: Feb. 16, 2024

Related U.S. Application Data
(63) Continuation of application No. PCT/JP2022/029816, filed on Aug. 3, 2022.

(30) Foreign Application Priority Data
Aug. 19, 2021 (JP) 2021-133804

(51) Int. Cl. G21B 1/13

(52) U.S. Cl. CPC G21B 1/13

(57) ABSTRACT

A nuclear fusion reactor blanket includes: a first wall; a front side flow path disposed behind the first wall and extending along the first wall; a supply path that supplies a coolant to the front side flow path from an outside of the blanket; an internal tank disposed behind the front side flow path; a front side wall that has a plurality of inflow holes communicating between the front side flow path and the internal tank; a discharge path that discharges the coolant from the internal tank to the outside of the blanket.

### RELATED APPLICATIONS

This is a continuation of PCT Application No. PCT/JP2022/029816 filed on Aug. 3, 2022. The contents of the parent application and Japanese Patent Application No. 2021-133804 filed on Aug. 19, 2021, on the basis of which priority benefits are claimed, are incorporated herein by reference in their entirety.

### BACKGROUND

### Technical Field

Embodiments of the present disclosure relate to a nuclear fusion reactor blanket and a nuclear fusion reactor.

### Description of Related Art

In a nuclear fusion reactor, a mixed fuel containing deuterium and tritium is converted into plasma and held in a vacuum vessel, and energy is extracted from primary neutrons with 14.1 MeV produced by a nuclear fusion reaction, thereby generating power. Since tritium does not exist in nature, it is required to breed while compensating for consumption of tritium in order to continuously operate the furnace. Therefore, in the nuclear fusion reactor, a blanket is attached to an inner surface of the vacuum vessel in order to perform tritium production by capturing neutrons produced by the nuclear fusion reaction and recovery of heat generated by the nuclear fusion reaction.

As an example of the blanket, there is a blanket in which layers of a tritium breeding material containing lithium and a neutron breeding material containing beryllium are alternately provided in a box-shaped metal vessel (housing) formed of specially component-adjusted reduced activation ferrite steel (for example, F82H). A flow path through which cooling water flows is formed inside the housing, and generated heat is recovered. A pipe for supplying and recovering cooling water and a pipe for supplying and recovering carrier gas for recovering produced tritium are attached to the housing (see, for example, JP2004-239807A).

### SUMMARY

According to an aspect of the disclosure, there is provided a nuclear fusion reactor blanket including: a first wall; a front side flow path disposed behind the first wall and extending along the first wall; a supply path that supplies a coolant to the front side flow path from an outside of the blanket; an internal tank disposed behind the front side flow path; a front side wall that has a plurality of inflow holes communicating between the front side flow path and the internal tank; and a discharge path that discharges the coolant from the internal tank to the outside of the blanket.

According to another aspect of the disclosure, there is provided a nuclear fusion reactor including: a vacuum vessel; and a plurality of blanket arranged along an inside of the vacuum vessel, wherein at least one of the plurality of blanket includes: a first wall; a front side flow path disposed behind the first wall and extending along the first wall; a supply path that supplies a coolant to the front side flow path from an outside of the vacuum vessel; an internal tank disposed behind the front side flow path; a front side wall that has a plurality of inflow holes communicating between the front side flow path and the internal tank; and a discharge path that discharges the coolant from the internal tank to the outside of the vacuum vessel.

### BRIEF DESCRIPTION OF THE DRAWINGS

FIG. 1 is a perspective view illustrating a configuration of a tokamak type nuclear fusion reactor according to an embodiment in a partially cutaway manner.

FIG. 2 is an explanatory view schematically illustrating a state in which a nuclear fusion reactor blanket is disposed on an inner surface of a vacuum vessel in an embodiment.

FIG. 3 is a perspective view illustrating an external configuration of a blanket module according to an embodiment.

FIG. 4 is a cross-sectional view illustrating an internal configuration of a blanket module according to an embodiment.

### DETAILED DESCRIPTION

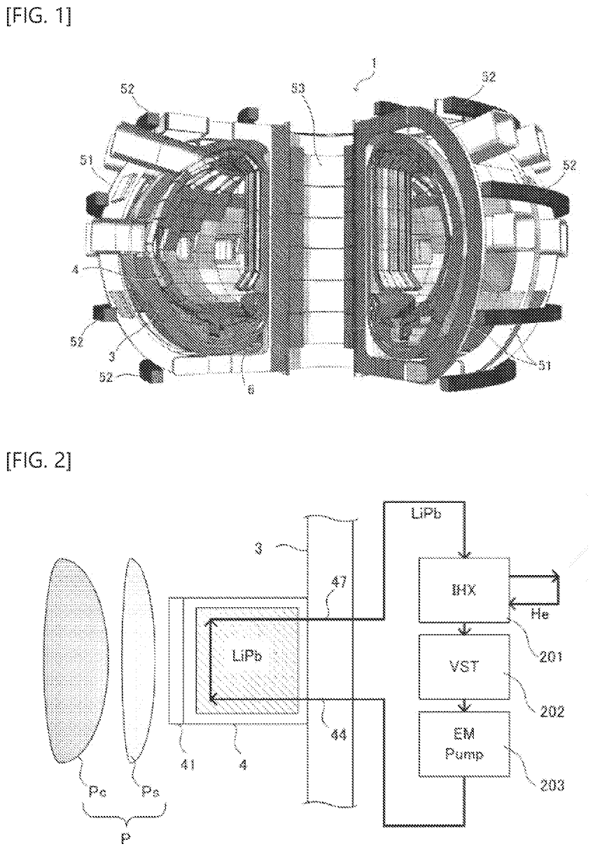

Hereinafter, embodiments of a nuclear fusion path blanket according to the present invention will be described in detail with reference to the accompanying drawings. FIG. 1 illustrates a configuration of a nuclear fusion reactor according to the present embodiment. Note that the embodiment described below exemplifies a device and the like for embodying the technical idea of the invention, and the technical idea of the invention does not specify a material, shape, structure, arrangement, and the like of each component as follows. Various modifications can be made to the technical idea of the invention within the scope of the claims.

### Configuration of Nuclear Fusion Reactor

In a nuclear fusion reactor 1 illustrated in FIG. 1, a mixed fuel containing deuterium and tritium is plasma-converted in a vacuum vessel 3. The produced high-temperature plasma is held inside the vacuum vessel 3 by a magnetic field generated by each of superconducting coils 51 to 53 or the like. Then, a nuclear fusion reaction of deuterium and tritium occurs inside the plasma. Note that a diverter 6 exhausts helium and fuel particles produced by the nuclear fusion reaction, and discharges heat energy flowing to the diverter 6.

More specifically, the nuclear fusion reactor 1 is a so-called tokamak type nuclear fusion reactor, and is provided with the vacuum vessel 3 having a donut shape and a substantially D-shaped vertical cross section. A superconducting coil is provided outside the vacuum vessel 3, and the superconducting coil is maintained in a low temperature state. As the superconducting coil, a toroidal coil 51, a poloidal coil 52, and a center solenoid coil 53 are provided in a space outside the vacuum vessel 3.

The center solenoid coil 53 is provided in a space at the center of the donut of the vacuum vessel 3. A plurality of toroidal coils 51 are arranged at intervals along a large diameter of the vacuum vessel 3. Each of the plurality of toroidal coils 51 is arranged so as to surround a donut-shaped cylindrical portion of the vacuum vessel 3. In each of the toroidal coils 51, currents in the same direction flow along the large diameter of the vacuum vessel 3. In addition, the poloidal coil 52 has an annular shape formed along the large diameter of the vacuum vessel 3, that is, a plurality of poloidal coils 52 are arranged concentrically with the donut-shaped large diameter at intervals from each other in the vertical direction.

A toroidal magnetic field formed by the toroidal coil 51 is a combined magnetic field of the magnetic fields formed by the plurality of arranged toroidal coils 51. The toroidal magnetic field is formed along the large diameter of the vacuum vessel 3 in the vacuum vessel 3. Hereinafter, a direction of the toroidal magnetic field is referred to as a toroidal direction, and a region outside the magnetic field is also used. In addition, a poloidal magnetic field formed by the poloidal coil 52 is a combined magnetic field of magnetic fields formed by a plasma current induced in the plasma. This poloidal magnetic field is formed in the vacuum vessel 3 along a vertical cross section of a donut-shaped cylindrical portion of the vacuum vessel 3.

An overall combined magnetic field formed by combining these magnetic fields is an overall combined magnetic field of the toroidal magnetic field and the poloidal magnetic field. The overall combined magnetic field is a magnetic field formed along the donut-shaped surface and twisted toward the central axis of the plasma.

In the nuclear fusion reactor 1, a mixed fuel containing deuterium and tritium is converted into plasma in the vacuum vessel 3, and a produced high-temperature nuclear fusion plasma P (core plasma Pc and sol plasma Ps illustrated in FIG. 2) is held inside the vacuum vessel 3 by the overall combined magnetic field by the toroidal coil 51, the poloidal coil 52, and the like. Inside the nuclear fusion plasma, a nuclear fusion reaction of deuterium and tritium occurs, and helium and neutrons are produced.

A diverter coil is provided below the poloidal coil 52 in the vertical direction, and as a result of overlapping of the magnetic field by the diverter coil and the poloidal magnetic field, a null point at which the poloidal magnetic field becomes 0, and a plasma boundary, which is a magnetic force surface including a null point, are generated. Outside the plasma boundary, the magnetic field lines do not remain inside, and therefore, the plasma particles present in the region outside the plasma boundary flow out along the plasma boundary. The diverter 6 is provided to capture the particles and thermal energy inside the vacuum vessel 3. The diverter 6 exhausts helium and the like produced by the nuclear fusion reaction, and discharges and recovers heat energy flowing to the diverter 6.

Note that, in addition to the diverter 6, some of an electron cyclotron heating (ECH) device for applying energy to the nuclear fusion plasma, a neutral beam injection heating (NBI) device for injecting high-energy particles into the plasma, and the like are also provided inside the vacuum vessel 3.

### Configuration of Blanket

Further, in the vacuum vessel 3, a nuclear fusion reactor blanket 4 is provided along the inner surface of the vacuum vessel 3 so as to surround the nuclear fusion plasma. The nuclear fusion reactor blanket 4 is a nuclear fusion reactor blanket including a plurality of blanket modules 4a. As illustrated in FIG. 2, each of the blanket modules 4a is arranged so as to surround the periphery of the nuclear fusion plasma P so that a first wall 41 of a front surface of a housing 40 faces the nuclear fusion plasma P.

The blanket module 4a is arranged inside the vacuum vessel 3, a coolant (liquid lithium lead) is supplied from a supply pipe 44 to the inside of the housing 40, heat generated in the housing 40 and tritium are recovered by the coolant, the heat and tritium are recovered by a heat exchanger (intermediate heat exchanger: IHX) 201 and a vacuum sieve tray (VST) device 202 via the coolant discharged to the outside of the vacuum vessel 3 through a discharge pipe 47, and the coolant is supplied to the blanket module 4a again by an electromagnetic pump (EM pump) 203.

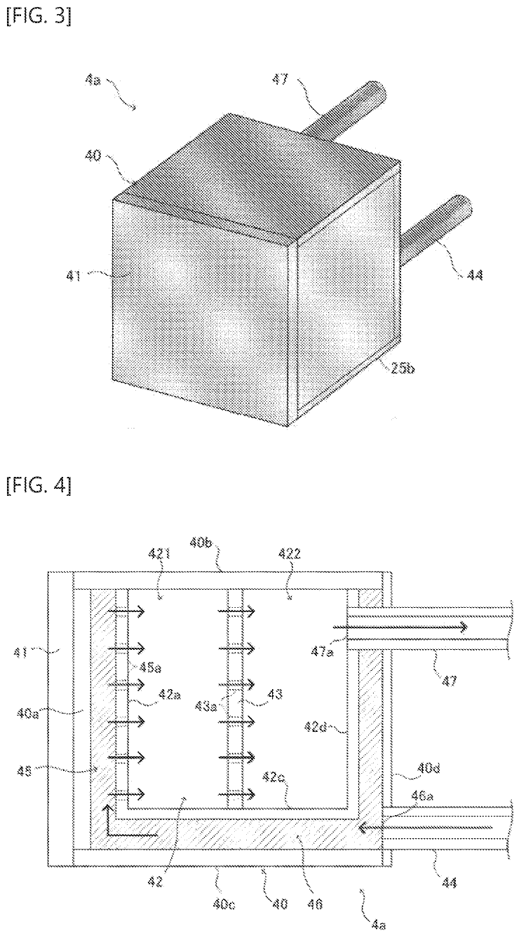

FIGS. 3 and 4 illustrate an external configuration and an internal configuration of the blanket module 4a according to an embodiment. As illustrated in FIG. 3, each blanket module 4a is a structure having the cuboidal housing 40 as a base body in appearance, and has a configuration in which the coolant supplied from the supply pipe 44 is circulated inside the housing 40 and is delivered from the discharge pipe 47 to the outside.

Internally, as illustrated in FIG. 4, there are provided an internal tank 42 formed inside the housing 40, a supply path 46 and a front side flow path 45 which communicate with the supply pipe 44 for supplying a coolant from the outside of the housing 40, and a discharge pipe 47 which communicates with the outside of the housing 40 from the internal tank 42. Note that, in the present embodiment, the flow paths from the supply pipe 44 to the discharge pipe 47 are arranged in the horizontal direction.

The housing 40 is a hollow cuboidal box disposed behind the first wall 41 and having six faces formed by a structural material including a silicon carbide composite material (SiCf/SiC: SiC or a SiC composite material) having a density of 3.21 g/cm³. The housing 40 accommodates the front side flow path 45, the internal tank 42, and the supply path 46. The first wall 41 is a quadrangular plate disposed to face the nuclear fusion plasma, and a tungsten thin film is applied to a surface facing the nuclear fusion plasma P. Note that the tungsten thin film in the present embodiment has a thickness of 0.1 mm.

The internal tank 42 is a watertight space separated inside the housing 40 by a material similar to the silicon carbide composite material constituting the housing 40, and a plurality of internal tanks are connected in a direction away from the nuclear fusion plasma in the hollow inside the housing 40. The internal tank 42 is surrounded by a front side wall 42a, a lower side wall 42c, and a back side wall 42d, for example. In the present embodiment, the internal tank 42 is divided into a plurality of tanks by a partition wall 43 to form a plurality of (two tanks in the present embodiment) internal tanks 421 and 422. In addition, a large number of inflow holes 45a communicating with the inside and the outside of the internal tank 421 are drilled in a plasma side front surface 42a (i.e., the front side wall 42a) of the internal tank 42, and the coolant flows from the outside to the inside of the internal tank 421. A plurality of inflow holes 45a may be arranged along the front side flow path 45. The plurality of inflow holes 45a may communicate in a direction intersecting a direction in which the first wall 41 extends. The plurality of inflow holes 45a may communicate in the horizontal direction. The plurality of inflow holes 45a may communicate in a direction away from the first wall 41. Similarly, a large number of communication holes 43a that allow the adjacent internal tanks 421 and 422 to communicate with each other are also drilled in the partition wall 43, and the coolant flows from the internal tank 421 on the plasma side to the internal tank 422 on the rear side. A plurality of communication holes 43a may communicate in a direction intersecting the direction in which the first wall 41 extends. The plurality of communication holes 43a may communicate in the horizontal direction. The plurality of communication holes 43a may communicate in a direction away from the first wall 41.

In the periphery of the internal tank 42, a gap portion from the inner wall of the housing 40 serves as a supply path for a coolant. The inner wall of the housing 40 may comprise a front wall 40a, an upper wall 40b, a lower wall 40c, and a back wall 40d. In the present embodiment, the supply pipe 44 connected to the lower portion of the housing 40 communicates with the supply path 46 formed around the internal tank 42, the supply path 46 communicates with the front side flow path 45 formed between a structural material 40a on a side of the first wall 41 (i.e., the front wall 40a) and the internal tank 421 located in the foremost row in the housing 40, and the coolant is supplied into the internal tank 421 from the supply path 46 and the front side flow path 45 through the inflow hole drilled in a structural material 42a of the internal tank 421.

In the present embodiment, a lead pipe formed of a silicon carbide composite material (SiCf/SiC: SiC or a SiC composite material) and having a thickness of 1 mm and a length of 10 cm is adopted as each of the supply pipe 44 and the discharge pipe 47. The supply pipe 44 penetrates through a structural material 40d on a back surface of the housing 40 at a lower portion on the back surface of the housing 40 and communicates with the supply path 46 inside the housing 40. In the present embodiment, the supply path 46 and the supply pipe 44 inside the housing 40 serve as supply paths for supplying a coolant from the outside of the housing 40. On the other hand, the discharge pipe 47 penetrates through structural material 40d on the back surface of the housing 40 and the structural material 42d on the back surface of the internal tank 422 at the lower portion of the back surface of the housing 40, and communicates with the inside of the internal tank 422. In the present embodiment, the discharge pipe 47 serves as a discharge path for discharging the coolant from the last internal tank 422 to the outside of the housing 40.

In the present embodiment, the coolant circulated in the above blanket module 4a is a fluid containing lithium lead having a function of a breeding material. The lithium lead (LiPb) is a fluid having both functions of a coolant and a breeding material, and in the present embodiment, when the lithium lead is irradiated with primary neutrons produced by a nuclear fusion reaction, a nuclear reaction of lithium having a mass number of 6 contained in the lithium lead as a coolant occurs, and tritium is produced. At the same time, a nuclear reaction between lithium lead contained in the coolant and primary neutrons occurs, and secondary neutrons are produced. The secondary neutrons also undergo a nuclear reaction with the coolant in the nuclear fusion reactor blanket 4 to contribute to tritium production. Note that it is possible to achieve a tritium breeding ratio >1 even with lithium lead having a natural Li ratio (⁶Li ratio: 7.8%) by filling beryllium as a coolant. At the same time, in the nuclear fusion reactor blanket 4, heat generated from plasma is recovered via lithium lead which is a coolant supplied and circulated inside the housing 40.

### Operation of Nuclear Fusion Reactor

An operation of the nuclear fusion reactor having the configuration described above is as follows.

First, a mixed fuel containing deuterium and tritium is plasma-converted inside the vacuum vessel 3. The produced high-temperature plasma is held inside the vacuum vessel 3 by a magnetic field generated by a coil of the superconducting coils 51 to 53 or the like. Then, inside the plasma, a nuclear fusion reaction of deuterium and tritium occurs, and helium and neutrons are produced. A part of the particles and the thermal energy is captured inside the vacuum vessel 3 by the diverter 6, and the diverter 6 exhausts helium and the like produced by the nuclear fusion reaction, and the thermal energy flowing into the diverter 6 is discharged and recovered.

On the other hand, in the nuclear fusion reactor blanket 4, in each blanket module 4a, a coolant (liquid lithium lead) is supplied into the housing 40 through the supply pipe 44 by the electromagnetic pump 203, and heat and tritium produced in the housing 40 are recovered by the supplied coolant and discharged to the outside of the vacuum vessel 3 through the discharge pipe 47. Heat and tritium are recovered by the heat exchanger 201 and the VST device 202 via the coolant discharged from each blanket module 4a. Then, the coolant is supplied to the blanket module 4a again by the electromagnetic pump 203.

Specifically, the electromagnetic pump 203 supplies the coolant (liquid lithium lead) to the inside of the housing 40 through the supply pipe 44, the coolant supplied into the housing 40 is passed through the supply path 46 formed around the internal tank 42 and flows to the front side flow path 45 formed between the structural material 40a on the side of the first wall 41 and the internal tank 421 located in the foremost row, and then, the coolant is supplied into the internal tank 421 from the front side flow path 45 through an inflow hole drilled in the structural material 42a of the internal tank 421. In addition, in the internal tank 42, the coolant flows from the internal tank 421 on the plasma side to the internal tank 422 on the rear side through a large number of communication holes 43a drilled in the partition wall 43. As described above, the coolant captures heat and tritium produced in the housing 40 while passing through the internal tanks 421 and 422 from the supply pipe 44 through the supply path 46 and the front side flow path 45.

During this time, since the coolant is liquid lithium lead and has a function of a breeding material, the coolant is irradiated with primary neutrons produced by the nuclear fusion reaction, such that a nuclear reaction of lithium having a mass number of 6 contained in the lithium lead occurs, and tritium is produced, and at the same time, a nuclear reaction between the lithium lead contained in the coolant and the primary neutrons occurs, and secondary neutrons are produced. The secondary neutrons also undergo a nuclear reaction with the coolant in the nuclear fusion reactor blanket 4 to contribute to tritium production.

Thereafter, the coolant is discharged from the last internal tank 422 to the outside of the housing 40 through the discharge pipe 47 in a state of capturing heat and tritium, and the heat and tritium are recovered by the heat exchanger 201 and the VST device 202 via the coolant discharged from each blanket module 4a.

### Action and Effect

According to the nuclear fusion reactor blanket 4 according to the present embodiment described above, it is possible to design a blanket that can be operated at a high temperature using an advanced silicon carbide composite material (SiCf/SiC) and a self-cooling lithium lead breeding material. Specifically, a tungsten thin film is adopted for the first wall 41, a silicon carbide composite material (SiCf/SiC) is adopted as a structural material of the blanket module 4a, and liquid lithium lead serves as a breeding material and a coolant, and therefore, the nuclear fusion reactor blanket 4 plays a role of extracting heat generated by nuclear fusion, producing tritium, and shielding radiation. In addition, since lithium lead is a non-compressible fluid and has low chemical reactivity with air or water, it is safe even in a possible accident scenario such as leakage. Furthermore, since lithium lead is circulated and cooled, it is not required to put a coolant such as pressurized water or helium gas inside the blanket, and a simple blanket structure becomes possible.

In addition, in the present embodiment, since the structure is a structure in which a plurality of internal tanks 42 are connected inside the housing 40, and the housing 40, the internal tanks 42, and each flow path are formed of a structural material containing SiC or a SiC composite material, the size or arrangement of the internal tanks 42 can be optimized, the flow path for the coolant can be controlled according to the nuclear heat generation distribution, and the heat recovery rate and tritium breeding performance can be appropriately improved. In addition, in the blanket 4 of the present embodiment, each flow path from the supply pipe 44 to the discharge pipe 47 is arranged horizontally, and the coolant can flow with small pump power.

In addition, since a SiCf/SiC structural material having a density of 3.21 g/cm³ is used for each structural material or pipe of the housing 40, the housing is excellent in lightweight properties, is lighter than a steel material (about 8 g/cm³), and has extremely low hydrogen isotope permeation as compared with a steel structural material. In a blanket using SiCf/SiC as a structural material, problems caused by fuel loss or leakage of radioactive substances due to tritium permeation hardly occur.

Furthermore, SiCf/SiC is excellent in thermochemical stability and damage recovery even under a high temperature and neutron irradiation, and can be replaced less frequently than conventional materials, and the maintenance cost can be reduced. In addition, since SiCf/SiC has significantly less reflection and absorption of neutrons than other steel materials, a high tritium breeding ratio can be achieved.

In addition, in the blanket module according to the present embodiment, all the structural materials thereof generate radioisotopes by neutron irradiation and are treated as radioactive waste. A level of activation of SiCf/SiC is significantly lower as compared to other structural materials such as low activation ferritic steel, and SiCf/SiC reduces activity by more than three orders of magnitude per day, which makes it possible to significantly reduce the amount of radioactive waste. Furthermore, in a case where lithium lead is allowed to flow in a steel material, MHD pressure loss such as a phenomenon in which a strong brake acts on a flow of liquid lithium lead in a blanket becomes a problem, but in SiCf/SiC, MHD pressure loss does not occur in principle. In addition, since silicon and carbon are abundantly present in nature, the SiCf/SiC material has a small environmental load and can be stably procured.

In addition, the first wall 41 of the present embodiment is coated with a tungsten thin film, and therefore, high heat load resistance can be obtained and the occurrence of sputtering of neutral particles can be reduced. In addition, tungsten and SiCf/SiC have a small difference in coefficient of thermal expansion, and it is also possible to secure bondability between the first wall 41 and the housing 40.

In addition, in the blanket module according to the present embodiment, liquid lithium lead is used as a coolant, and a silicon carbide composite material (SiCf/SiC: SiC or a SiC composite material) is adopted as a structural material, and therefore, stability is hidden because these materials exhibit excellent coexistence at a high temperature. That is, SiCf/SiC is stable even at a temperature of higher than 1,000° C., can be circulated at a much higher temperature compared to other coolants, does not cause chemical corrosion, which is a significant problem for steel structural materials, and is available at a high temperature, and therefore, more than 55% of power generation efficiency is achieved using a high efficiency Brayton cycle.

Note that, in a case of using pressurized water as the coolant, the thermal efficiency is about 33%. In addition, in the case of using pressurized cooling water, there is an unavoidable risk of accidents, such as the production of hydrogen in the event of a cooling water loss accident, in a case where pressurized cooling water is blown into a high-temperature area due to damage to structural materials. On the other hand, in the blanket module according to the present embodiment, since the cooling water is not used in the self-cooling, this cooling water loss accident does not occur in principle. Note that, in a case of a system using water or helium as a coolant, it is important to reduce an assumed leakage of a primary coolant accompanied with tritium contamination, and it is required to prepare a suppression pool in a case where helium or water expands in volume in preparation for a possible environmental contamination threat.

Furthermore, since the blanket module according to the present embodiment can have a simple structure without using a fine pipe, it is possible to reduce safety concerns and potential risks of the entire plant due to a complicated reactor design, and it is possible to realize high tritium breeding performance while maintaining structural soundness of the entire plant.

Furthermore, in a case where beryllium is blended as a coolant in the present invention, a necessary amount of beryllium can be disposed at a high position of a fast neutron flux that induces a beryllium breeding reaction (Be+n->2He+2n), such that a tritium breeding ratio can be adjusted. In particular, in the present invention, lithium lead or beryllium is blended at a natural ratio, such that it is possible to eliminate the need for highly concentrated lithium lead (6Li concentration: about 90%) which is significantly expensive or to reduce the amount used, and it is possible to reduce the cost.

Conventionally, when the cooling water is used to recover the generated heat, a risk such as production of hydrogen cannot be avoided in a case where the cooling water is blown into a high-temperature portion due to breakage of a structural material. In particular, when a pipe for circulating cooling water or a pipe for supplying and recovering carrier gas for recovering purified tritium becomes complicated, it becomes one of safety concerns and potential risks of the entire plant.

Therefore, an aspect of the present disclosure has been made in view of such circumstances, and an object of the present invention is to provide a nuclear fusion reactor blanket that realizes high tritium breeding performance while maintaining structural soundness of the entire plant by making a reactor design simple and lightweight.

An aspect of the present disclosure provides a nuclear fusion reactor blanket including a plurality of blanket modules arranged along an inside of a vacuum vessel of a nuclear fusion reactor for producing nuclear fusion plasma, in which each of the plurality of blanket modules includes: a first wall disposed to face the nuclear fusion plasma; an internally hollow housing disposed behind the first wall and formed of a structural material containing SiC or a SiC composite material; a plurality of internal tanks connected in a direction away from the nuclear fusion plasma in the hollow inside the housing; a front side flow path formed between a structural material on a side of the first wall and an internal tank located in a foremost row in the housing; an inflow hole that allows the front side flow path and the internal tank located in the foremost row to communicate with each other; a communication hole that allows adjacent internal tanks to communicate with each other; a supply path that supplies a coolant from the outside of the housing to the front side flow path; and a discharge path that discharges the coolant from the last internal tank to the outside of the housing.

In the above aspect, the coolant is preferably lithium lead or beryllium having a function of a breeding material, or a fluid containing these components in combination. In addition, in the above invention, the first wall preferably includes a tungsten thin film. Furthermore, in the above invention, at least one of the supply path or the discharge path preferably includes a pipe material formed of a structural material containing Sic or a Sic composite material.

According to the aspect of the present disclosure, in a nuclear fusion reactor blanket disposed along an inside of a vacuum vessel of a nuclear fusion reactor for producing nuclear fusion plasma, it is possible to realize high tritium breeding performance while maintaining structural soundness of the entire plant by making a reactor design simple and lightweight. More specifically, in the present invention, since a housing is formed of a structural material containing SiC or a SiC composite material, and a plurality of internal tanks are connected inside the housing, the size and arrangement of the internal tanks can be optimized, the flow path can be controlled according to the nuclear heat generation distribution, and the heat recovery rate and the tritium breeding performance can be appropriately improved. In addition, in the conventional blanket, a beryllium-filled layer cannot be installed, and some blankets have a structure in which lithium lead flows in a vertical direction. For example, when there is a lift of 10 m or more, significantly large pump power and power consumption are involved. On the other hand, in the blanket module of the present invention, the supply path and the discharge path can be arranged in a horizontal direction, and the coolant can flow with small pump power.

Furthermore, in a case where beryllium is blended as a coolant in the present invention, a necessary amount of beryllium can be disposed at a high position of a fast neutron flux that induces a beryllium breeding reaction (Be+n->2He+2n), such that a tritium breeding ratio can be adjusted. In particular, in the present invention, lithium lead or beryllium is blended at a natural ratio, such that it is possible to eliminate the need for highly concentrated lithium lead (6Li concentration: about 90%) which is significantly expensive or to reduce the amount used, and it is possible to reduce the cost.

Although some embodiments of the present invention have been described above, these embodiments have been presented as examples, and are not intended to limit the scope of the invention. These novel embodiments can be implemented in various other forms, and various omissions, substitutions, and changes can be made without departing from the gist of the invention. These embodiments and modifications thereof are included in the scope and gist of the invention, and are included in the invention described in the claims and the equivalent scope thereof.

P nuclear fusion plasma, Pc core plasma, Ps sol plasma, 1 nuclear fusion reactor, 3 vacuum vessel, 4 nuclear fusion reactor blanket, 4a blanket module, 6 diverter, 40 housing, 40a to 40d structural material, 41 first wall, 42 internal tank, 42a to 42d structural material, 43 partition wall, 43a communication hole, 44 supply pipe, 45 front side flow path, 45a inflow hole, 46 supply path, 47 discharge pipe, 51 toroidal coil, 52 poloidal coil, 53 center solenoid coil, 201 heat exchanger, 202 VST device, 203 electromagnetic pump, 421, 422 internal tank.

What is claimed is:

1. A nuclear fusion reactor blanket comprising:
a first wall;
a front side flow path disposed behind the first wall and extending along the first wall;
a supply path that supplies a coolant to the front side flow path from an outside of the blanket;
an internal tank disposed behind the front side flow path;
a front side wall that has a plurality of inflow holes communicating between the front side flow path and the internal tank; and
a discharge path that discharges the coolant from the internal tank to the outside of the blanket.

2. The nuclear fusion reactor blanket according to claim 1, wherein the plurality of inflow holes are arranged along the front side flow path.

3. The nuclear fusion reactor blanket according to claim 1, wherein the plurality of inflow holes communicate in a direction intersecting a direction in which the first wall extends.

4. The nuclear fusion reactor blanket according to claim 1, wherein the plurality of inflow holes communicate in a horizontal direction.

5. The nuclear fusion reactor blanket according to claim 1, wherein the plurality of inflow holes communicate in a direction away from the first wall.

6. The nuclear fusion reactor blanket according to claim 1, wherein the first wall is disposed to face nuclear fusion plasma.

7. The nuclear fusion reactor blanket according to claim 1, further comprising:
a partition wall that divides an inside of the internal tank into a plurality of tanks and that has a plurality of communication holes communicating between adjacent tanks.

8. The nuclear fusion reactor blanket according to claim 7, wherein the plurality of communication holes communicate in a direction intersecting a direction in which the first wall extends.

9. The nuclear fusion reactor blanket according to claim 7, wherein the plurality of communication holes communicate in a horizontal direction.

10. The nuclear fusion reactor blanket according to claim 7, wherein the plurality of communication holes communicate in a direction away from the first wall.

11. The nuclear fusion reactor blanket according to claim 1, further comprising:
a housing that accommodates the front side flow path, the internal tank, and the supply path.

12. The nuclear fusion reactor blanket according to claim 11, wherein the housing comprising a structural material containing SiC or a SiC composite material.

13. The nuclear fusion reactor blanket according to claim 1, wherein the front side wall comprising a structural material containing SiC or a SiC composite material.

14. The nuclear fusion reactor blanket according to claim 7, wherein the partition wall comprising a structural material containing SiC or a SiC composite material.

15. The nuclear fusion reactor blanket according to claim 1, wherein the coolant is a fluid containing lithium lead.

16. The nuclear fusion reactor blanket according to claim 1, wherein the coolant is a fluid containing beryllium.

17. The nuclear fusion reactor blanket according to claim 1, wherein the first wall comprises tungsten.

18. The nuclear fusion reactor blanket according to claim 1, wherein at least one of the supply path and the discharge path comprises a pipe material including a structural material containing SiC or a SiC composite material.

19. A nuclear fusion reactor comprising:
a vacuum vessel; and
a plurality of blanket arranged along an inside of the vacuum vessel,
wherein at least one of the plurality of blanket comprises:
a first wall;
a front side flow path disposed behind the first wall and extending along the first wall;
a supply path that supplies a coolant to the front side flow path from an outside of the vacuum vessel;
an internal tank disposed behind the front side flow path;
a front side wall that has a plurality of inflow holes communicating between the front side flow path and the internal tank; and
a discharge path that discharges the coolant from the internal tank to the outside of the vacuum vessel.

20. The nuclear fusion reactor according to claim 19, further comprising at least one of:
a heat exchanger that recovers heat from the coolant discharged via the discharge path; and
a pump that supplies the coolant discharged via the discharge path to the supply path.
